(19) United States
(12) Patent Application Publication
(10) Pub. No.: US 2019/0378075 A1
(43) Pub. Date: Dec. 12, 2019

(54) FORECASTING VOYAGE-LEVEL NET PROMOTOR SCORES

(71) Applicant: Royal Caribbean Cruises Ltd., Miami, FL (US)

(72) Inventors: Sol Rashidi, Miami Beach, FL (US); Arya Eskamani, Miami, FL (US)

(21) Appl. No.: 16/006,811

(22) Filed: Jun. 12, 2018

(51) Int. Cl. G06Q 10/06; G06Q 10/04

(52) U.S. Cl. CPC G06Q 10/06393; G06Q 10/047

(57) ABSTRACT

Embodiments of the invention provide a method, system and computer program product for voyage-level prediction of a net promoter score (NPS) data set for a collection of passengers scheduled for transport by a vehicle. The method includes classifying a past set of completed voyages according to a discrete set of classifications, each referring to a different characteristic of a corresponding one of the completed voyages, ingesting survey responses from passengers of the completed voyages and correlating the responses to an associated one of the different classifications, scheduling a new voyage for a specific vehicle, determining a set of classifications for the new voyage, extrapolating hypothetical survey responses for the new voyage based upon the determined set of classifications for the new voyage and displaying the hypothetical survey responses in a display of an onboard computing system of the specific vehicle.

### BACKGROUND OF THE INVENTION

### Field of the Invention

The present invention relates to the field of net promoter score (NPS)

### Description of the Related Art

Metrics and key performance indicators (KPIs) are measurable values used by marketing, sales, hotel operations, and executive steering committees to demonstrate the effectiveness of offerings and campaigns across all distributing channels. Central to the computation of these metrics and KPI's is the customer satisfaction survey. Customer satisfaction refers to the measurement in marketing of how products and services supplied by a company meet or surpass customer expectations. Customer satisfaction is defined as the number of customers, or percentage of total customers, whose reported experience in the form of a rating, with a firm, its products, or its services exceeds specified satisfaction goals.

The NPS is a metric recently developed that specifically measures the willingness of customers to recommend the products or services of a company to others. Thus, the NPS is used as a proxy for gauging the overall satisfaction of the customer with the product or service of the company and loyalty of the customer to the brand of a product or service. To calculate the NPS, customers each are surveyed with respect to a single question. Specifically, the single question requests the customer to rate on an eleven-point scale the likelihood of recommending the company or brand to a friend or colleague. The prototypical question is, “On a scale of 0 to 10, how likely are you to recommend this company's product or service to a friend or a colleague?” Based upon the resultant rating, customers are then classified into three distinct categories: detractors, passives and promoters.

‘Detractors’ assign a score lower or equal to six and thus, are neither pleased with the product or the service, nor likely to purchase the product or service again from the company. Therefore, the opinion of a ‘detractor’ could potentially damage the reputation of the company through negative word of mouth. ‘Passives’ assign a mid-range score of seven or eight and thus are somewhat satisfied with the product or service, but could readily switch to a competitive product or service given the opportunity. While the ‘passive’ is unlikely to spread negative word-of-mouth, the ‘passive’ lacks enthusiasm so as to likely promote the goods or services of the company. Finally, ‘Promoters’ assign a high score off nine or ten and thus have great enthusiasm for the products or services of the company. ‘Promotors’ tend to be repeat buyers and often recommend the products and services of the company to other potential buyers.

Operationally, the NPS is computed by subtracting the percentage of customers who are detractors from the percentage of customers who are promoters. The resultant value is a score between negative one-hundred and positive one-hundred. At one extreme, an NPS of negative one-hundred indicates an absolute unwillingness of customers to recommend products or services of the company to others. Conversely, at the other extreme, an NPS of positive one-hundred indicates an absolute willingness of customers to recommend products or services of the company to others. In either circumstance, however, since the NPS is based upon accumulated data from customers already having purchased the product or service, for those customers avoiding a poor NPS is not possible.

### BRIEF SUMMARY OF THE INVENTION

Embodiments of the present invention address deficiencies of the art in respect to NPS determination and provide a novel and non-obvious method, system and computer program product for voyage-level prediction of an NPS data set for a collection of passengers scheduled for transport by a vehicle. In an embodiment of the invention, a method for voyage-level prediction of an NPS data set for a collection of passengers scheduled for transport by a vehicle includes classifying a past set of completed voyages according to a discrete set of voyage classifications, with each classification referring to a different characteristic of a corresponding one of the completed voyages. The method also includes ingesting survey responses from passengers of the completed voyages and correlating the ingested survey responses from each of the passengers of a corresponding one of the completed voyages to an associated one of the different classifications for the corresponding one of the completed voyages. Finally, the method includes scheduling a new voyage for a specific vehicle and determining a set of classifications for the new voyage, extrapolating hypothetical survey responses for the new voyage based upon the determined set of classifications for the new voyage and displaying the hypothetical survey responses in a display of an onboard computing system of the specific vehicle.

In one aspect of the embodiment, the method additionally includes transforming the hypothetical survey responses to an NPS score for the new voyage and displaying the NPS score in the display. In another aspect of the embodiment, the method includes re-classifying the new voyage subsequent to the displaying of the NPS score with a new set of classifications for the new voyage, extrapolating new hypothetical survey responses for the new voyage based upon the new set of classifications for the new voyage, transforming the new hypothetical survey responses to a new NPS score for the new voyage and displaying the new hypothetical survey responses and the new NPS score in the display of the onboard computing system of the specific vehicle. In yet another aspect of the embodiment, the NPS score is produced by generating an index of numerical values indicating a mix of promoters, neutrals and detractors forming the NPS score based upon a normalization of numerical data corresponding to the ingested survey responses as reduced into a set of equivalent indices that are statistically proportional to an amount of information in the ingested survey responses and provided as input to a generalized linear model.

In another embodiment of the invention, a data processing system configured for voyage-level prediction of an NPS data set for a collection of passengers scheduled for transport by a vehicle includes a host computing system with memory and at least one processor, fixed storage and a display. The system also includes a voyage-level prediction module that has computer program instructions executing in the memory of the host computing system. The program instructions are adapted upon execution to classify a past set of completed voyages according to a discrete set of voyage classifications, with each classification referring to a different characteristic of a corresponding one of the completed voyages, to ingest survey responses from passengers of the completed voyages and correlate the ingested survey responses from each of the passengers of a corresponding one of the completed voyages to an associated one of the different classifications for the corresponding one of the completed voyages, to schedule a new voyage for a specific vehicle, determine a set of classifications for the new voyage, extrapolate hypothetical survey responses for the new voyage based upon the determined set of classifications for the new voyage and display the hypothetical survey responses in a display of an onboard computing system of the specific vehicle.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for voyage-level prediction of an NPS data set for a collection of passengers scheduled for transport by a vehicle;

FIG. 2 is a schematic diagram of a data processing system adapted for voyage-level prediction of an NPS data set for a collection of passengers scheduled for transport by a vehicle; and,

FIG. 3 is a flow chart illustrating a process for voyage-level prediction of an NPS data set for a collection of passengers scheduled for transport by a vehicle.

### DETAILED DESCRIPTION OF THE INVENTION

Embodiments of the invention provide for voyage-level prediction of an NPS data set for a collection of passengers scheduled for transport by a vehicle. In accordance with an embodiment of the invention, a past set of voyages are each classified according to a discrete set of classifications such as voyage duration, number of passengers and destination, to name a few examples, so that every one of the voyages is classified according to a selected sub-set of the classifications. Survey results are collected for each one of the voyages in the set from different passengers of the voyages. In this regard, the survey results may include for each passenger, a single numeric rating on a scale of zero to ten in response to a question regarding the likelihood that the passenger will recommend a corresponding voyage to another. For each one of the voyages, corresponding survey results are assigned to each classification of the corresponding one of the voyages. Thereafter, in response to the scheduling of a new voyage, the new voyage is classified according to the same set of discrete classifications according to its own sub-set of the classifications. As such, hypothetical survey results for the newly scheduled but not yet conducted voyage can be extrapolated based upon the values assigned to each classification in the sub-set of classifications for the newly scheduled voyage. Further, as the newly scheduled voyage is reclassified based upon changes in the nature of the prospective voyage, the hypothetical survey results can be re-extrapolated so as to allow for the optimization of the prospective voyage in respect to desired survey results.

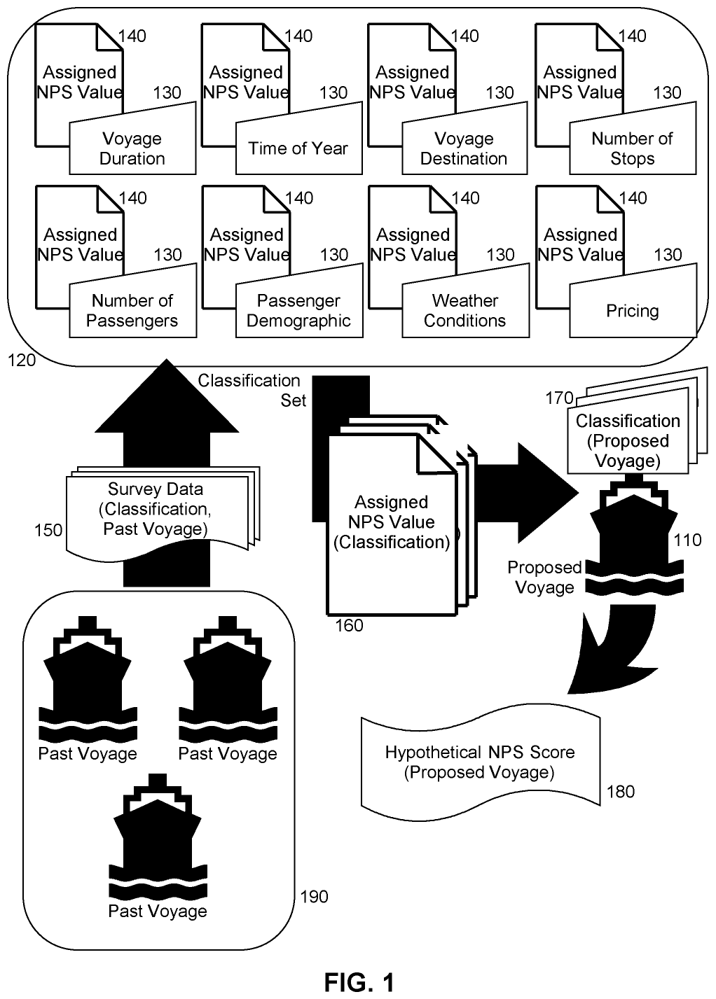

In further illustration, FIG. 1 pictorially depicts a process for voyage-level prediction of an NPS data set for a collection of passengers scheduled for transport by a vehicle. As shown in FIG. 1, survey data 150 is collected for a past set of voyages 190, such as a past set of airline flights, a past set of train trips, a motor coach tour or seaborn cruise. The survey data 150 includes responses to survey questions and, in one aspect of the invention, a numerical score in the range of zero to ten in respect to whether or not the surveyed passenger would recommend a corresponding voyage to another. For each corresponding one of the voyages in the past set of voyages 190, the survey data 150 from each passenger of the corresponding one of the voyages is aggregated into an NPS value 140. The aggregated NPS value 140 is then associated with each of a corresponding one of several different classifications 130 identified for the corresponding one of the voyages and stored in a classification set 120.

By way of example, an exemplary table of the different classifications 130 in the classification set 120 appears as follows:

As can be seen, the different classifications 130 in the classification set 120 may include among others, a duration of the corresponding one of the voyages, a time of year of the corresponding one of the voyages, a destination of the corresponding one of the voyages, a number of stops between an origination and the destination of the corresponding one of the voyages, a number of passengers on board during the corresponding one of the voyages, a particular demographic make-up of the corresponding one of the voyages, weather conditions experienced during the corresponding one of the voyages, and pricing for the corresponding one of the voyages.

Thereafter, a new voyage 110 is proposed and a subset of classifications 170 from the classification set 120 are assigned to the new voyage 110 based upon expected characteristics of the new voyage 110. For each selected one of the classifications in the subset of classifications 170, an associated NPS value 160 is retrieved from the classification set 120 and the associated NPS values 160 are aggregated into a hypothetical NPS score 180 for the proposed, new voyage 110. Once the hypothetical NPS score 180 for the proposed new voyage 110 has been determined, the subset of classifications 170 may change prior to the new voyage 110 resulting in the computation of a new hypothetical NPS score 180 for the proposed new voyage 110. As well, once the new voyage 110 has commenced, the subset of classifications 170 again may change resulting in yet another new hypothetical NPS score 180.

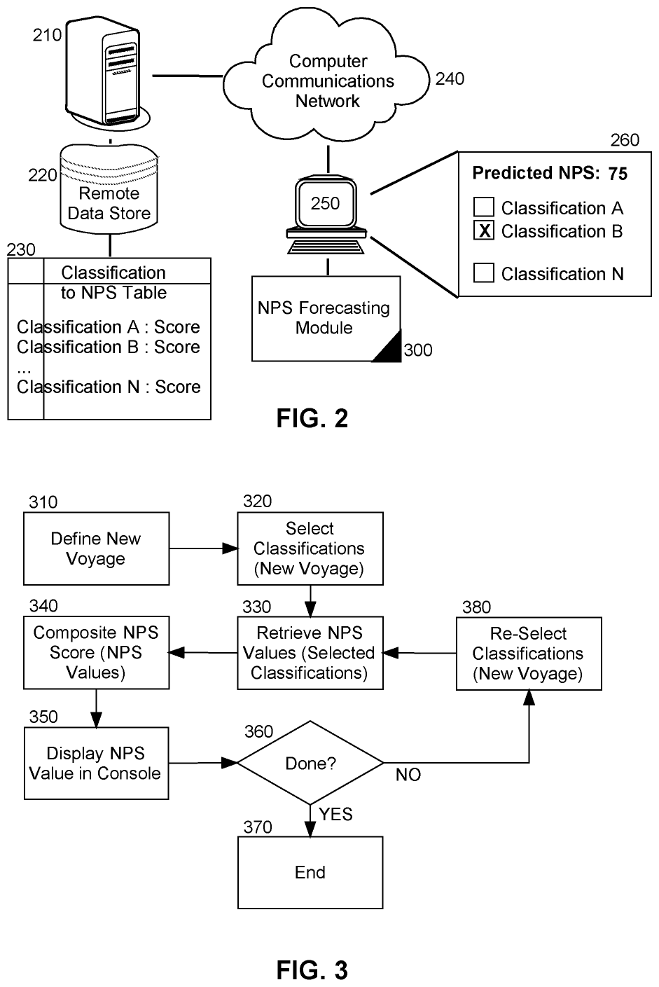

The process described in connection with FIG. 1 may be implemented in a data processing system. In yet further illustration, FIG. 2 schematically shows a data processing system adapted for voyage-level prediction of an NPS data set for a collection of passengers scheduled for transport by a vehicle. The system includes a host computing system 210 the includes memory and at least one processor and a corresponding data store 220 in which data may be stored. The data store 220 specifically stores therein, a classification to NPS table 230 in which different classifications for a set of past voyages are associated with an aggregate of all survey results received from passengers in connection with one of the past voyages in the set having the corresponding classification. For instance, the survey results may be a value such as an average value derived from all NPS scores for each of the past voyages having the corresponding characteristic.

As it will be understood, the classification to NPS table 230 correlates NPS scores for different, past voyages to specific characterizations of those different, past voyages. Consequently, a review of a single one of the characterizations and associated NPS score suggests that all past voyages having the single one of the characterizations, received the associated NPS score. Further, a correlation may be drawn as between specific characterizations and a resulting associated NPS score. As a result, specific voyage characteristics can predict particularly poor NPS scores or particularly good NPS scores so as to influence the organization of a future voyage to avoid characteristics associated with particularly poor NPS scores, while including characteristics associated with particularly good NPS scores.

A client computer 250 may be coupled to the data processing system 210 over computer communications network 240 and may be disposed in onboard a vehicle for a proposed, new voyage. An NPS forecasting module 300 includes computer program instructions executing in the client computer 250. The program instructions are enabled during execution to generate a user interface 260 in a display of the client computer 250 the permits a selection of a subset of the classifications referenced in the classification to NPS table 230 so as to characterize the proposed, new voyage. Responsive to the selection of the subset of the classifications, the program code of the NPS forecasting module 300 is enabled to compute and display a predicted NPS score for the proposed, new voyage by retrieving an associated NPS score for each selected classification in the user interface 260 and producing an average value. Optionally, different ones of the retrieved associated NPS scores may be weighted dependent upon a perceived importance of the corresponding classification in the subset. As it will be understood, the process may repeat for each variation of the composition of the subset of the classifications selected in the user interface 260.

In even yet further illustration of the operation of the NPS forecasting module, FIG. 3 is a flow chart illustrating a process for voyage-level prediction of an NPS data set for a collection of passengers scheduled for transport by a vehicle. Beginning in block 310, a new voyage is defined in memory of a computer. In block 320, a set of pre-defined classifications are selected in characterization of the new voyage. In block 330, an NPS value for each of the selected characterizations is retrieved and in block 340, the retrieved NPS values are composited into a single NPS score which may be displayed in a console in block 350. In decision block 360, it is determined if the process has completed. If not, in block 380 a new set of classifications are selected for the new voyage and the process repeats in block 330. Otherwise, the process ends in block 370.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for voyage-level prediction of a net promotor score (NPS) data set for a collection of passengers scheduled for transport by a vehicle, the method comprising:
classifying a past set of completed voyages according to a discrete set of voyage classifications, each classification referring to a different characteristic of a corresponding one of the completed voyages;
ingesting survey responses from passengers of the completed voyages;
correlating the ingested survey responses from each of the passengers of a corresponding one of the completed voyages to an associated one of the different classifications for the corresponding one of the completed voyages;
scheduling a new voyage for a specific vehicle and determining a set of classifications for the new voyage;
extrapolating hypothetical survey responses for the new voyage based upon the determined set of classifications for the new voyage; and,
displaying the hypothetical survey responses in a display of an onboard computing system of the specific vehicle.

2. The method of claim 1, further comprising transforming the hypothetical survey responses to an NPS score for the new voyage and displaying the NPS score in the display.

3. The method of claim 2, further comprising:
re-classifying the new voyage subsequent to the displaying of the NPS score with a new set of classifications for the new voyage; and,
extrapolating new hypothetical survey responses for the new voyage based upon the new set of classifications for the new voyage;
transforming the new hypothetical survey responses to a new NPS score for the new voyage; and,
displaying the new hypothetical survey responses and the new NPS score in the display of the onboard computing system of the specific vehicle.

4. The method of claim 2, wherein the NPS score is produced by generating an index of numerical values indicating a mix of promoters, neutrals and detractors forming the NPS score based upon a normalization of numerical data corresponding to the ingested survey responses as reduced into a set of equivalent indices that are statistically proportional to an amount of information in the ingested survey responses and provided as input to a generalized linear model.

5. A data processing system configured for voyage-level prediction of a net promotor score (NPS) data set for a collection of passengers scheduled for transport by a vehicle, the system comprising:
a host computing system comprising memory and at least one processor, fixed storage and a display; and,
a voyage-level prediction module comprising computer program instructions executing in the memory of the host computing system, the program instructions being adapted upon execution by the at least one process of the host computing system to perform:
classifying a past set of completed voyages according to a discrete set of voyage classifications, each classification referring to a different characteristic of a corresponding one of the completed voyages;
ingesting survey responses from passengers of the completed voyages;
correlating the ingested survey responses from each of the passengers of a corresponding one of the completed voyages to an associated one of the different classifications for the corresponding one of the completed voyages;
scheduling a new voyage for a specific vehicle and determining a set of classifications for the new voyage;
extrapolating hypothetical survey responses for the new voyage based upon the determined set of classifications for the new voyage; and,
displaying the hypothetical survey responses in a display of an onboard computing system of the specific vehicle.

6. The system of claim 5, wherein the program instructions are further adapted to perform transforming the hypothetical survey responses to an NPS score for the new voyage and displaying the NPS score in the display.

7. The system of claim 6, wherein the program instructions are further adapted to perform:
re-classifying the new voyage subsequent to the displaying of the NPS score with a new set of classifications for the new voyage; and,
extrapolating new hypothetical survey responses for the new voyage based upon the new set of classifications for the new voyage;
transforming the new hypothetical survey responses to a new NPS score for the new voyage; and,
displaying the new hypothetical survey responses and the new NPS score in the display of the onboard computing system of the specific vehicle.

8. The system of claim 5, wherein the NPS score is produced by generating an index of numerical values indicating a mix of promoters, neutrals and detractors forming the NPS score based upon a normalization of numerical data corresponding to the ingested survey responses as reduced into a set of equivalent indices that are statistically proportional to an amount of information in the ingested survey responses and provided as input to a generalized linear model.

9. A computer program product for voyage-level prediction of a net promotor score (NPS) data set for a collection of passengers scheduled for transport by a vehicle, the computer program product including a computer readable storage medium having program instructions embodied therewith, the program instructions executable by a device to cause the device to perform a method including:
classifying a past set of completed voyages according to a discrete set of voyage classifications, each classification referring to a different characteristic of a corresponding one of the completed voyages;
ingesting survey responses from passengers of the completed voyages;
correlating the ingested survey responses from each of the passengers of a corresponding one of the completed voyages to an associated one of the different classifications for the corresponding one of the completed voyages;
scheduling a new voyage for a specific vehicle and determining a set of classifications for the new voyage;
extrapolating hypothetical survey responses for the new voyage based upon the determined set of classifications for the new voyage; and,
displaying the hypothetical survey responses in a display of an onboard computing system of the specific vehicle.

10. The computer program product of claim 9, wherein the program instructions are further enabled to perform transforming the hypothetical survey responses to an NPS score for the new voyage and displaying the NPS score in the display.

11. The computer program product of claim 10, wherein the program instructions are further enabled to perform:
re-classifying the new voyage subsequent to the displaying of the NPS score with a new set of classifications for the new voyage; and,
extrapolating new hypothetical survey responses for the new voyage based upon the new set of classifications for the new voyage;
transforming the new hypothetical survey responses to a new NPS score for the new voyage; and,
displaying the new hypothetical survey responses and the new NPS score in the display of the onboard computing system of the specific vehicle.

12. The computer program product of claim 10, wherein the NPS score is produced by generating an index of numerical values indicating a mix of promoters, neutrals and detractors forming the NPS score based upon a normalization of numerical data corresponding to the ingested survey responses as reduced into a set of equivalent indices that are statistically proportional to an amount of information in the ingested survey responses and provided as input to a generalized linear model.
